(19) United States
(12) Patent Application Publication
(10) Pub. No.: US 2021/0076278 A1
(43) Pub. Date: Mar. 11, 2021

(54) METHODS AND APPARATUS FOR CELL RE-SELECTION IN NEW RADIO SYSTEM

(71) Applicants: Zhixun TANG, Bejing (CN); Yuanyuan ZHANG, Bejing 100016 (CN); Tsang-Wei YU, Hsinchu (TW); Li-Chuan TSENG, Hsinchu (TW); Media Tek Singapore Pte. Ltd., Singapore (SG)

(72) Inventors: Zhixun TANG, Bejing (CN); Yuanyuan ZHANG, Bejing (CN); Tsang-Wei YU, Hsinchu (TW); Li-Chuan TSENG, Hsinchu (TW)

(73) Assignees: Media Tek Singapore Pte. Ltd., Singapore (SG); Zhixun TANG, Bejing (CN); Yuanyuan ZHANG, Bejing (CN); Tsang-Wei YU, Hsinchu (TW); Li-Chuan TSENG, Hsinchu (TW)

(21) Appl. No.: 16/964,747

(22) PCT Filed: May 15, 2019
(86) PCT No.: PCT/CN2019/087012

§ 371 Date: Jul. 24, 2020

(30) Foreign Application Priority Data
May 16, 2018 (CN) PCT/CN2018/087145

(51) Int. Cl. H04W 36/08; H04W 36/00; H04W 36/30

(52) U.S. Cl. CPC H04W 36/08; H04W 76/28; H04W 36/30; H04W 36/0085

(57) ABSTRACT

Aspects of the disclosure can provide an apparatus and method for cell reselection in a New Radio (NR) system. In some examples, the apparatus includes transceiver and processing circuitry. The processing circuitry ranks a priority list of frequencies which correspond to a plurality of cells, wherein the cells are part of a NR system. The plurality of cells can include a current serving cell, one or more inter-frequency cells, and one or more intra-frequency cells. The processing circuitry measures reference signal received power (RSRP) and/or reference signal received quality (RSRQ) of the cells in the priority list of frequencies in an unused synchronization signal block (SSB) time location in a discontinuous reception (DRX) cycle. Further, the processing circuitry can select a new serving cell when the measured signal performance of the new serving cell satisfies a cell selection criteria.

### INCORPORATION BY REFERENCE

This present disclosure claims the benefit of International Application No. PCT/CN2018/087145, filed on May 16, 2018, which is incorporated herein by reference in its entirety.

### TECHNICAL FIELD

The present disclosure relates to wireless communications, and specifically relates to cell reselection processing in a New Radio (NR) system.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

The mobile communication system has grown exponentially over the years. The 3^{rd} generation partnership project (3GPP), which has developed the most successful standard technologies in mobile communication market, such as Universal Mobile Telecommunication System (UMTS) and Long Term Evolution (LTE), is currently carrying out the standardization of the fifth generation (5G) system (5GS), which includes a core network and an access network.

A 5G New Radio (NR) system is designed to make use of SSB (Synchronization Signal Block) to execute the signal strength and quality measurement. SSB is periodical transmission based on its SMTC (SSB Based RRM Measurement Timing Configuration) periodicity. SMTC periodicity is one of the values among {5, 10, 20, 40, 80, 160} ms. In idle mode, a UE (User Equipment) generally will use DRX (Discontinuous Reception) technique to reduce power consumption. The UE periodically go into sleep mode and wake up to monitor paging information on each DRX on duration. Generally, idle mode paging cycle could be believed as DRX cycle. Basically, DRX cycle is one of the values among {320, 640, 1280, 2560} ms in idle mode. Accordingly, it is important for the UE to properly schedule measurement and perform cell re-selection based on above configuration.

### SUMMARY

Aspects of the disclosure provide an apparatus and a method for cell reselection in a New Radio (NR) system. In some examples, the apparatus includes transceiver and processing circuitry. The processing circuitry ranks a priority list of frequencies which correspond to a plurality of cells, wherein the cells are part of a New Radio (NR) system. The plurality of cells can include a current serving cell, at least an inter-frequency cell, or/and at least an intra-frequency cell. The processing circuitry measures a signal performance of the cells in the priority list of frequencies in an unused synchronization signal block (SSB) time location in a discontinuous reception (DRX) cycle. Further, the processing circuitry selects a new serving cell when the measured signal performance of the new serving cell satisfies a cell selection criteria.

According to an aspect of the disclosure, the processing circuitry ranks the priority list of frequencies based on the priorities of the frequencies that are configured by system information of the NR system.

In an embodiment, the processing circuitry measure the signal performance that includes reference signal received power (RSRP) and/or reference signal received quality (RSRQ) of the current serving cell in any SSB time location in each DRX cycle when SSB is Time Division Multiplexed (TDMed) with paging data.

In another embodiment, the processing circuitry measure the signal performance that includes reference signal received power (RSRP) and/or reference signal received quality (RSRQ) of the current serving cell in any SSB time location in each DRX cycle except SSB time location that is used by paging when SSB is Frequency Division Multiplexed (FDMed) with paging data.

In an embodiment, the processing circuitry selects one or more frequencies in descending order from the priority list that the frequencies correspond to one or more inter-frequency cells and measures, in round-robin manner, the signal performances that includes RSRP and/or RSRQ of the respective inter-frequency cells at SSB time location that are not used by paging, the current serving cell, and cells in higher-priority frequencies.

In another embodiment, the processing circuitry selects a frequency from the priority list that the frequency corresponds to one or more intra-frequency cells and measures, in round-robin manner, the signal performance that includes RSRP and/or RSRQ of the respective intra-frequency cells at SSB time location that are not used by paging, the current serving cell, and cells in higher-priority frequencies.

In an embodiment, the processing circuitry selects an inter-frequency cell corresponding to highest priority inter-frequency as the new serving cell when there are at least two inter-frequency cells in which the measured signal performance satisfies the cell selection criteria 1.

In another embodiment, the processing circuitry selects an intra-frequency cell as the new serving cell when there are at least two intra-frequency cells in which the measured signal performance satisfies the cell selection criteria.

In another embodiment, the processing circuitry stays in the current serving cell when the measured signal performance of current serving cell satisfies the cell selection criteria and there is no inter-frequency cell or intra-frequency cell in which the measured signal performance satisfies the cell selection criteria.

Aspects of the disclosure can further provide a method for cell reselection in the NR system, including ranking, by a processing circuitry of user equipment (UE), a priority list of frequencies that correspond to a plurality of cells that are part of a communication system, where the plurality of cells includes a current serving cell, an inter-frequency cell, and an intra-frequency cell, measuring a signal performance of the cells in the priority list of frequencies in an unused synchronization signal block (SSB) time location in a discontinuous reception (DRX) cycle, and selecting a new serving cell when the measure signal performance of the new serving cell satisfies a cell selection criteria.

Aspects of the disclosure can further provide a non-transitory computer readable medium storing instructions which, when executed by a processor, cause the processor to perform ranking a priority list of frequencies that correspond to a plurality of cells that are part of a communication system, where the plurality of cells includes a current serving cell, an inter-frequency cell, and an intra-frequency cell, measuring a signal performance of the cells in the priority list of frequencies in an unused synchronization signal block (SSB) time location in a discontinuous reception (DRX) cycle, and selecting a new serving cell when the measured signal performance of the new serving cell satisfies a cell selection criteria.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary wireless communication system according to an embodiment of the disclosure;

FIG. 2 is a flowchart showing an exemplary cell reselection procedure according to an embodiment of the disclosure;

FIG. 3 shows an exemplary diagram for serving cell and inter-frequencies measurements according to an embodiment of the disclosure;

FIG. 4 shows another exemplary diagram for serving cell and inter-frequencies measurements according to an embodiment of the disclosure; and

FIG. 5 shows an exemplary block diagram of a UE according to an embodiment of the disclosure.

### DETAILED DESCRIPTION OF EMBODIMENTS

Aspects of the disclosure provide apparatus and methods for cell reselection in a New Radio (NR) system. Due to the user equipment (UE)'s mobility in the NR system, the cell reselection procedure allows the UE to select a more suitable cell and camp on it, so that the UE can maintain a high quality connection to the base station (BS) and achieve good user experience. In some examples, the apparatus includes a transceiver and processing circuitry. The processing circuitry includes a ranking module to rank a priority list of frequencies which correspond to a plurality of cells, wherein the cells are part of a New Radio (NR) system. The plurality of cells can include a current serving cell, at least an inter-frequency cell, or/and at least an intra-frequency cell. The processing circuitry also includes a measurement module to measures a signal performance of the cells in the priority list of frequencies for cell reselection evaluation. The processing circuitry further includes a scheduling module to schedule each frequency's measurement in an unused synchronization signal block (SSB) time location in a discontinuous reception (DRX) cycle based on their absolute priority and the required measurement interval. The processing circuitry can select a new serving cell when the measured signal performance of the new serving cell satisfies a cell selection criteria.

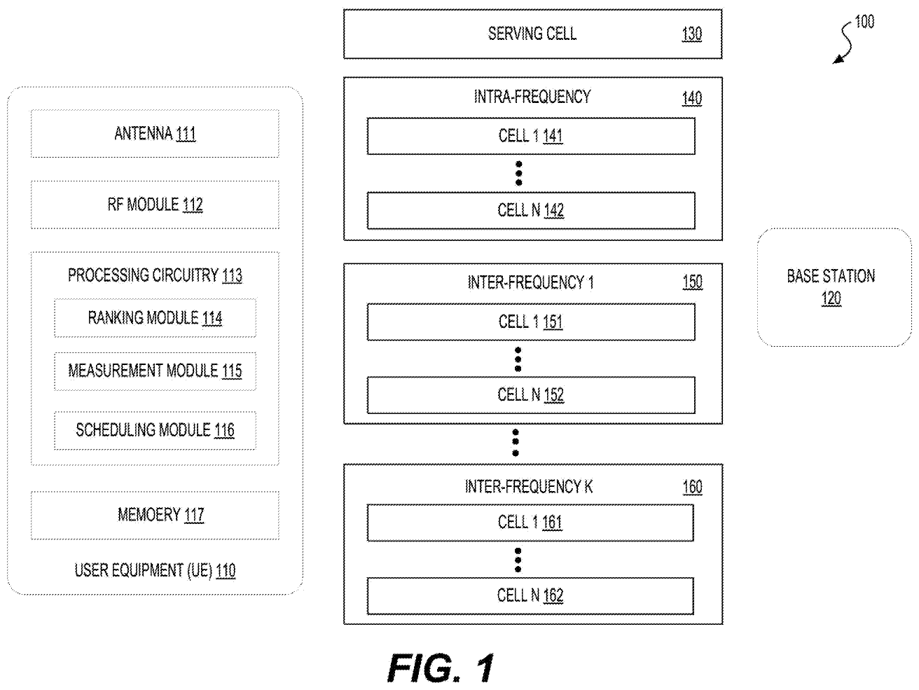

FIG. 1 shows an exemplary wireless communication system 100 according to an embodiment of the disclosure. As shown, the wireless communication system 100 can include user equipment (UE) 110 and a base station (BS) 120. The wireless communication system 100 can be any communication system wherein the UE 110 and the BS 120 can communicate with each other wirelessly. The technologies deployed between the UE 110 and the BS 120 in the wireless communication system 100 include, but are not limited to, Fifth Generation (5G) New Radio (NR), Long Term Evolution (LTE), Wi-Fi, and the like. In the FIG. 1 example, the wireless communication system 100 can be a cellular network that employs the 5G NR technologies and the LTE technologies which are developed by the 3^{rd} Generation Partnership Project (3GPP) for wireless communications between the UE 110 and the BS 120.

The UE 110 can be any apparatus or network element in the communication system capable of signal transmission and reception. For example, the UE 110 can be a mobile phone, a laptop computer, a tablet, a vehicle carried mobile communication device, a utility meter fixed at a certain location, a commercial product with wireless communication capability and the like. While only one UE 110 is depicted in the FIG. 1, it should be understood that any number UEs 110 can be distributed in the communication system.

In the FIG. 1 example, the UE 110 can include an antenna 111, an RF module 112, a processing circuitry 113, and a memory 117. The antenna 111 can include one or more antenna arrays. The processing circuitry 113 can further include a ranking module 114, a measurement module 115, and a scheduling module 116. The memory 117 can be any device or material that can place, keep, and retrieve electronic data, such as operating systems, program instructions, and the like. It can include a read only memory (ROM), a random access memory (RAM), a flash memory, a solid state memory, a hard disk drive, an optical disk drive, and the like.

Within the processing circuitry 113, the ranking module 114 can handle each frequency's priority which is provided by the configuration information of the wireless communication system 100. According to the each frequency's priority, the ranking module 114 can execute the program instructions stored in the memory 117 to generate a priority list of a plurality of frequencies. The measurement module 115 can execute the program instructions stored in the memory 117 to measure each frequency's reference signal received power (RSRP) and/or reference signal received quality (RSRQ) for cell reselection evaluation. The scheduling module 116 can execute the program instructions stored in the memory 117 to schedule each frequency's measurement based on the frequency's priority and a corresponding measurement intervals. It should be understood that the processing circuitry 113 of the UE 110 can include any other modules which can implement any other functionalities by executing the program instructions stored in the memory 117.

The BS 120 is a radio station which is located in an access network (AN) as part of the wireless communication system 100. The BS 120 implements one or more access technologies to communicate with the UE 110 and provide connections between the UE 110 and a core networks (CN) of the wireless communication system 100. In the present disclosure, the BS 120 can be an implementation of a Next Generation NodeB (gNB) which is specified in the 3GPP 5G NR standards.

In operation, the UE 110 can manage its mobility by measuring the RSRP and/or RSRQ of a plurality of cells. For example, one serving cell 130 can be configured between the UE 110 and the BS 120. The UE 110 can camp on the serving cell 130 in idle mode based on an initial cell search. At the same time, one or more cells 141-142 in intra-frequency 140, denoted as intra-frequency cells, can be configured between the UE 110 and the BS 120. The UE 110 can detect, synchronize, and monitor the one or more intra-frequency cells 141-142 indicated by the serving cell 130 to decide whether select a new serving cell from the intra-frequency cells 141-142 or continue to camp on serving cell 130. Multiple cells 151-152 and 161-162 in inter-frequencies 150 and 160, denoted as inter-frequency cells 151-152 and 161-162, can also be configured between the UE 110 and the BS 120. The UE 110 can identify new inter-frequency cells 151-152 and 161-162 and perform measurements of signals in the inter-frequency cells 151-152 and 161-162 if carrier frequency information of the inter-frequency cells 151-152 and 161-162 is provided by the serving cell 130.

The intra-frequency 140 and the inter-frequencies 150 and 160 can have different priorities. For example, a frequency having a higher priority than the frequency of the current serving cell 130 can be denoted as a higher priority frequency. Similarly, a frequency having a lower priority than the frequency of the current serving cell 130 can be denoted as a lower priority frequency. An equal priority frequency is defined when the frequency is the same as the frequency in the serving cell 130.

In the FIG. 1 example, the serving cell 130 can be configured first after an initial access procedure, and the intra-frequency cells 141-142 and the inter-frequency cells 151-152 and 161-162 can be subsequently configured through signaling on the serving cell 130. In some examples, the UE 110 can only support one or a portion of the frequencies 140, 150, and 160 due to the serving cell 130's configuration. In some other examples, the wireless communication system 100 can include other UEs (not shown in the FIG. 1). Comparing to the UE 110, the other UEs can support a different or a different portion of the frequencies 140, 150, and 160. In addition, the serving cell 130 can be shared between the UE 110 and the other UEs in the wireless communication system 100.

In an embodiment, the intra-frequency cells can only include a single cell in intra-frequency 140.

In another embodiment, the inter-frequency cells can have a cell in each of the inter-frequencies 150 and 160, respectively. In an alternative embodiment, the inter-frequency cells can have only a single cell in the inter-frequency 150 or in the inter-frequency 160.

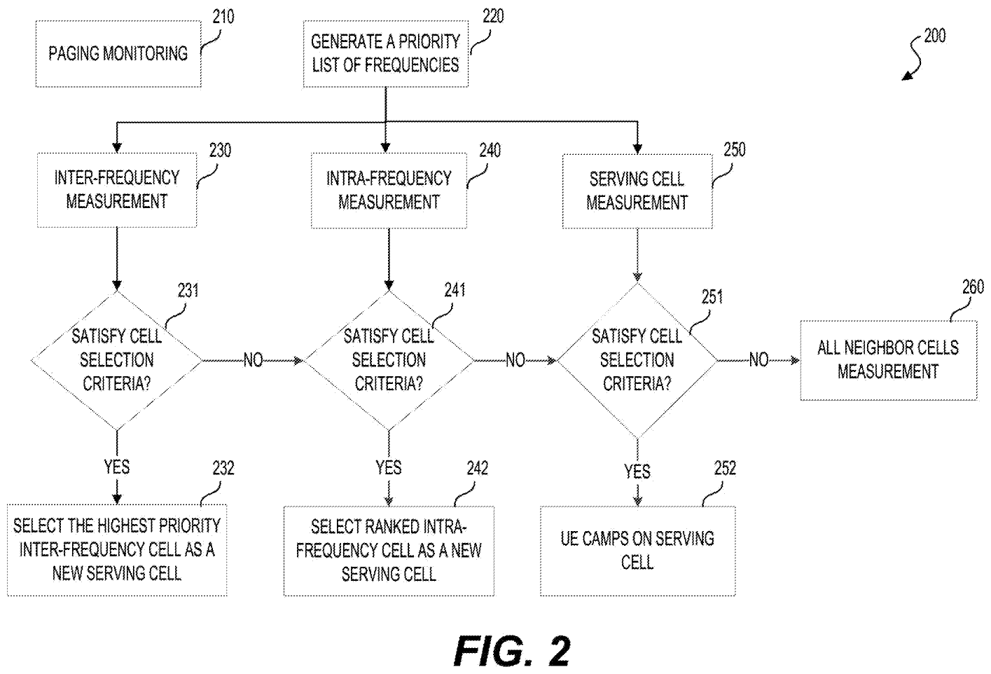

FIG. 2 illustrates an exemplary cell reselection procedure 200 according to an embodiment of the disclosure according to an embodiment of the disclosure. The cell reselection procedure 200 can be performed at the UE 110. The UE 110 monitors paging data 210 every DRX cycle. In order to avoid a SMTC collision with the paging monitoring, the UE 110 can choose unused SSB time locations within the DRX cycles to perform the inter-frequency measurement 230 of the inter-frequency cells 151-152 and 161-162, the intra-frequency measurement 240 of the intra-frequency cells 141-142, and the serving cell measurement 250 of the current serving cell 130. It should be understood that these measurements 230, 240, and 250 can be performed in a parallel manner or in a sequential order.

Before performing the measurements 230, 240, and 250, the UE 110 can generate a priority list of frequencies 220 based on the frequencies' priorities which are configured by the system information. For example, as shown in the FIG. 1, the system information originated from the network (e.g., CN) is received as wireless signals by the antenna 111 of the UE 110. Then the received wireless signals can be further decoded by the RF module 112 of the UE 110 and the system information can be recovered. The recovered system information includes the frequencies' priorities and can be further processed in the processing circuitry 113. In particular, the ranking module 114 in the processing circuitry 113 can execute the program instructions stored in the memory 117 to rank a plurality of frequencies based on the frequencies' priorities. Then the procedure 200 can proceed to 230, 240, and 250, respectively.

At 230, the UE can perform inter-frequency measurement 230 of the inter-frequency cells repeatedly in a measurement interval, wherein the measurement interval can be denoted as T_{measure,NR_Inter} which equals to N*DRX cycle. Herein, N is a positive integer.

In one embodiment, there can be two or more inter-frequency cells with various inter-frequency priorities. When the inter-frequency cells have different inter-frequencies, then the inter-frequency measurement 230 can be performed in round-robin manner. For example, the highest priority inter-frequency can be measured in a SSB time location first, and then the second highest priority inter-frequency can be measured in a different SSB time location. Each inter-frequency that has a higher priority than the frequency of the serving cell can be measured one by one in an unused SSB time location. The SSB time location should avoid the SSB time location that is used by the UE 110 to monitor paging (e.g., monitoring paging 210) and used by other measurements such as the serving cell measurement.

For example, as shown in the FIG. 1, the inter-frequency cells 151-152 and 161-162 have the inter-frequencies 150 and 160, respectively. Both the inter-frequency 1 (150) and the inter-frequency K (160) have higher priorities than the frequency of the current serving cell 130. The inter-frequency 1 (150) has a higher priority than the inter-frequency K (160). Therefore, the inter-frequency 1 (150) has the highest priority, Further, the cell 1 (151) has the highest priority among all the cells in the in the inter-frequency 150, so that the cell 1 (151) has a higher priority than the cell N (152).

The scheduling module 116 in the processing circuitry 113 can execute the program instructions stored in the memory 117 to schedule the measurement of the inter-frequency 1 (150) first since the inter-frequency 1 (150) has the highest priority in the ranked priority list. Further, the scheduling module 116 in the processing circuitry 113 can execute the program instructions stored in the memory 117 to schedule the measurement from the cell 1 (151) to the cell N (152) based on the respective measurement interval T_{measure,NR_Inter}. The cell 1 (151) is measured first since the cell 1 (151) has a higher priority than the cell N (152). Then, the measurement module 115 in the processing circuitry 113 can execute the program instructions stored in the memory 117 to measure the RSRP and/or RSRQ of the inter-frequency 1 (150) in an unused SSB time location for each inter-frequency cell 151-152. The unused SSB time location should avoid the SSB time locations which are used by the UE 110 to monitor paging and used by other measurements such as the serving cell measurement. The measurement results can be further stored in the memory 117 of the UE 110. Similarly, the UE 110 can perform the inter-frequency measurement of the inter-frequency K (160) for each inter-frequency cell 161-162. The measurement results can also be stored in the memory 117 of the UE 110. The procedure 200 can then proceed to 231.

At 231, the UE can check the measurement results to see whether any cell of the inter-frequency cells satisfies the cell selection criteria, wherein the cell selection criteria can be defined by the 3GPP standards. For example, as shown in the FIG. 1, the processing circuitry 113 of the UE 110 can execute the program instructions stored in the memory 117 to compare the measured RSRP and/or RSRQ of the inter-frequencies 150-160 to the cell selection criteria and select the inter-frequencies that satisfy the cell selection criteria. When at least one inter-frequency 150 or 160 satisfies the cell selection criteria, the procedure 200 can proceed to 232. Otherwise, the procedure 200 can proceed to 241.

At 232, the UE can select the highest priority inter-frequency cell as a new serving cell. For example, as shown in the FIG. 1, when both the inter-frequency 1 (150) and inter-frequency K (160) satisfy the cell selection criteria, the UE 110 can select a cell from the inter-frequency cells 151-152 since the inter-frequency 1 (150) has a higher priority than the inter-frequency K (160). Further, assume the cell 1 (151) has the highest inter-frequency priority among all the cells 151-152 in inter-frequency 150, then the UE 110 can select the cell 1 (151) as a new serving cell. In particular, the processing circuitry 113 can execute the program instructions stored in the memory 117 to generate a cell registration request that includes the information of the inter-frequency cell 1 (151) and then transfer the request to the RF module 112. The RF module 112 can convert the cell registration request to analog signals and send it to the BS 120 via the antenna 111. The cell registration request can further help the UE 110 register and connect to the new serving cell, which is the inter-frequency cell 1 (151).

At 240, the UE can perform intra-frequency measurement 240 of the intra-frequency cells repeatedly in a measurement interval, wherein the measurement interval can be denoted as T_{measure,NR_Intra} which equals to M*DRX cycle. Herein, M is a positive integer.

In one embodiment, there can be two or more intra-frequency cells with various priorities. The intra-frequency cells have the same frequency as the frequency of the serving cell. The intra-frequency measurement 240 of multiple intra-frequency cells can also be performed in round-robin manner. For example, a first intra-frequency cell with highest RSRP or/and RSRQ can be measured in a SSB time location first, and then a second intra-frequency cell with second highest RSRP or/and RSRQ can be measured in a different SSB time location. All the intra-frequency cells can be measured one by one in an unused SSB time location. The SSB time location should avoid the SSB time location that is used by the UE 110 to monitor paging (e.g., monitoring paging 210) and used by other measurements, such as measurements of other higher priority frequencies.

For example, as shown in the FIG. 1, the intra-frequency cells 141-142 have the intra-frequency 140. The intra-frequency 140 has the same priority as the frequency of the current serving cell 130. Further, the cell 1 (141) in the intra-frequency 140 has a higher priority than the cell N (142) in intra-frequency 140.

The scheduling module 116 in the processing circuitry 113 can execute the program instructions stored in the memory 117 to schedule the measurement of the intra-frequency 140. Further, the scheduling module 116 in the processing circuitry 113 can execute the program instructions stored in the memory 117 to schedule the measurement from the cell 1 (141) to the cell N (142) based on the respective measurement interval T_{measure,NR_Intra}. The cell 1 (141) is measured first since the cell 1 (141) has a higher priority than the cell N (142). Then, the measurement module 115 in the processing circuitry 113 can execute the program instructions stored in the memory 117 to measure the RSRP and/or RSRQ of the intra-frequency 140 in an unused SSB time location for each intra-frequency cell 141-142. Herein, the unused SSB time location should avoid the SSB time locations which are used by the UE 110 to monitor paging and used by other measurements such as measurements of other higher priority frequencies (e.g., higher priority inter-frequencies 150-160). The measurement results can be further stored in the memory 117 of the UE 110. The procedure 200 can then proceed to 241.

At 241, the UE can check the measurement results to see whether any cell of the intra-frequency cells satisfies the cell selection criteria. For example, as shown in the FIG. 1, the processing circuitry 113 of the UE 110 can execute the program instructions stored in the memory 117 to compare the measured RSRP and/or RSRQ of the intra-frequency cells 141-142 to the cell selection criteria and select the intra-frequency cells that satisfy the cell selection criteria. When one or more intra-frequency cells satisfy the cell selection criteria, then the procedure 200 can proceed to 242. Otherwise, the procedure 200 can proceed to 251.

At 242, the UE can select an intra-frequency cell (for example, an intra-frequency cell ranked with highest RSRP or/and RSRQ) as a new serving cell when the UE cannot find an inter-frequency cell with a higher priority than the intra-frequency cell that satisfies the cell selection criteria. For example, as shown in the FIG. 1, when both the intra-frequency cell 1 (141) and the intra-frequency cell N (142) can satisfy the cell selection criteria, and the UE 110 cannot find an inter-frequency cell with a higher priority than the intra-frequency cell 1 (141) or cell N (142) that satisfies the cell selection criteria, then the UE 110 can select the cell 1 (141) as a new serving cell since the cell 1 (141) ranked higher than the cell N (142). In particular, the processing circuitry 113 can execute the program instructions stored in the memory 117 to generate a cell registration request that includes the information of the intra-frequency cell 1 (141) and then transfer the request to the RF module 112. The RF module 112 can convert the cell registration request to analog signals and send it to the BS 120 via the antenna 111. The cell registration request can further help the UE 110 register and connect to the new serving cell, which is the intra-frequency cell 1 (141).

At 250, the UE can perform serving cell measurement 250 repeatedly in a measurement interval, wherein the measurement interval can be denoted as T_{measure,NR_serving}, which equals to one DRX cycle when SSB is Time Division Multiplexed (TDMed) with paging data, and equals to two DRX cycles when SSB is Frequency Division Multiplexed (FDMed) with paging data.

In one embodiment, when SSB is TDMed with paging data, the UE can monitor paging data and perform measurement in different SSB time locations. Therefore, the UE can perform the serving cell measurement in any available SSB time location in every DRX cycle.

In another embodiment, when SSB is FDMed with paging data, the UE can monitor paging data on each DRX cycle and perform measurement in any available SSB time location except the one that is used by paging monitoring 210.

For example, as shown in the FIG. 1, the scheduling module 116 in the processing circuitry 113 can execute the program instructions stored in the memory 117 to schedule the measurement of the serving cell 130 based on the measurement interval T_{measure,NR_serving}. In some examples, the serving cell 130 can be schedule to be measured in any SSB time location in every DRX cycle when SSB is TDMed with paging data. In some other examples, the serving cell 130 can be scheduled to be measured in any SSB time location except the one used by paging monitoring in every DRX cycle. Then, the measurement module 115 in the processing circuitry 113 can execute the program instructions stored in the memory 117 to measure the RSRP and/or RSRQ of the serving cell 130 in the scheduled SSB time locations. The measurement results can be further stored in the memory 117 of the UE 110. The procedure 200 can then proceed to 251.

At 251, the UE can check the measurement results to see whether the serving cell satisfies the cell selection criteria. For example, as shown in the FIG. 1, the processing circuitry 113 of the UE 110 can execute the program instructions stored in the memory 117 to compare the measured RSRP and/or RSRQ of the serving cell 130 to the cell selection criteria. When the serving cell 130 satisfies the cell selection criteria and no other inter-frequency cell 151-152 and 161-162 or intra-frequency cell 141-142 satisfies the cell selection criteria, the procedure 200 can proceed to 252. Otherwise, the procedure 200 can proceed to 260.

At 252, the UE stay in the serving cell. For example, as shown in the FIG. 1, when the serving cell 130 satisfies the cell selection criteria and no other inter-frequency cell 151-152 and 161-162 or intra-frequency cell 141-142 satisfies the cell selection criteria, the UE 110 can camp in the serving cell 130.

At 260, when the serving cell 130 does not satisfy the cell selection criteria, the UE 110 can perform measurements on all neighbor cells of the serving cell 130.

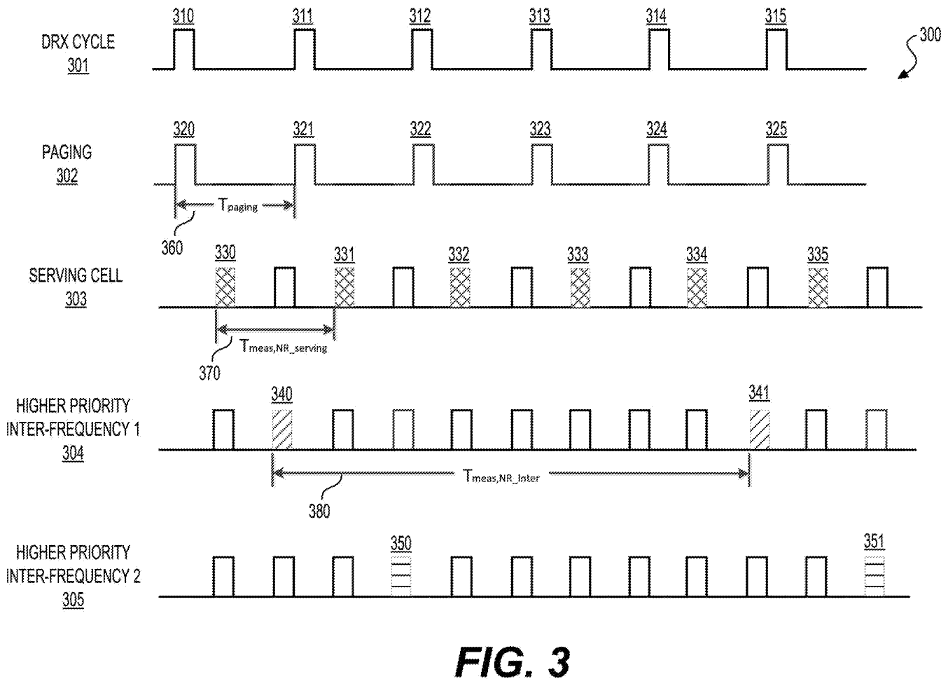

FIG. 3 shows an exemplary diagram 300 for serving cell and inter-frequencies measurements according to an embodiment of the disclosure. In the FIG. 3 example, SSB is TDMed with paging data. The UE can wake up during DRX on durations 310-315 and monitor paging data 302 in every DRX cycle 320-325, wherein the paging interval T_{paging} 360 equals to one DRX cycle. The UE performs a serving cell measurement 303, a higher priority inter-frequency 1 measurement 304, and a higher priority inter-frequency 2 measurement 305. The inter-frequency 1 304 has a higher priority than the inter-frequency 2 305.

The UE can perform the serving cell measurement 303 in any SSB time location in every DRX cycle, wherein the measurement interval T_{meas, NR_serving} 370 can equal to one DRX cycle. For example, the UE 110 can select the SSB time locations 330-335 to perform the serving cell measurement 303. Each SSB time location 330-335 is located in a DRX cycle and is not collided with the SSB time locations that are used by monitoring paging 302.

The UE can perform the higher priority inter-frequency 1 measurement 304 in an available SSB time location, wherein the measurement interval T_{meas, NR_Inter} 380 can equal to N*DRX cycle. N is a positive integer. The available SSB time location can be selected from time locations that are not used by monitoring paging 302 and the serving cell measurement 303. For example, the UE 110 can select the SSB time locations 340-341 to perform the higher priority inter-frequency 1 measurement 304. Each SSB time location 340-341 is not collided with the SSB time locations that are used by monitoring paging 302 and the serving cell measurement 303.

Similarly, the UE can perform the higher priority inter-frequency 2 measurement 305 in an available SSB time location, wherein the measurement interval T_{meas, NR_Inter} 380 can also equal to N*DRX cycle. The available SSB time location can be selected from time locations that are not used by monitoring paging 302, the serving cell measurement 303, and the higher priority inter-frequency 1 measurement 304. For example, the UE 110 can select the SSB time locations 350-351 to perform the higher priority inter-frequency 2 measurement 305. Each SSB time location 350-351 is not collided with the SSB time locations that are used by monitoring paging 302, the serving cell measurement 303, and the higher priority inter-frequency 1 measurement 304.

In the FIG. 3 example, the UE 110 can perform the serving cell measurements 303 in six SSB time locations 330-335. The SSB time locations 330-335 can be located in a continued DRX cycles 310-315. In some examples, the UE 110 can perform the serving cell measurements 303 and the higher priority inter-frequency 1 measurement 304 in the same DRX cycle but in different SSB time locations, such as 330 and 340 within the DRX cycle 310. In some other examples, the UE 110 can perform the serving cell measurements 303 and the higher priority inter-frequency 2 measurement 305 in the same DRX cycle, but in different SSB time locations, such as 331 and 350 within the DRX cycle 311.

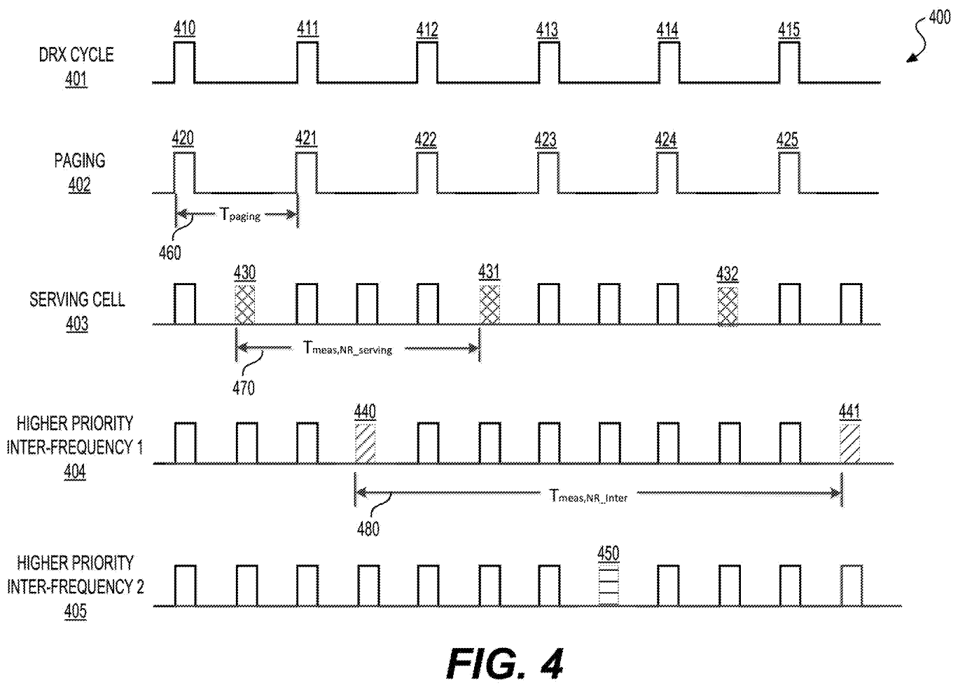

FIG. 4 shows another exemplary diagram 400 for serving cell and inter-frequencies measurements according to an embodiment of the disclosure. In the FIG. 4 example, SSB is FDMed with paging data. The UE can wake up during DRX on durations 410-415 and monitor paging data 402 in every DRX cycle 420-425, wherein the paging interval T_{paging} 460 equals to one DRX cycle. The UE can perform a serving cell measurement 403, a higher priority inter-frequency 1 measurement 404, and a higher priority inter-frequency 2 measurement 405, respectively. The inter-frequency 1 measurement 404 has a higher priority than the inter-frequency 2 measurement 405.

The UE can perform the serving cell measurement 403 in any SSB time location except the one used by the monitoring paging 402, and the measurement interval T_{meas, NR_serving} 470 can equal to two DRX cycles. For example, the UE 110 can select the SSB time locations 430-432 to perform the serving cell measurement 403. Each SSB time location 430-432 is located in every two DRX cycles and is not collided with the SSB time locations that are used by monitoring paging 402.

The UE can perform the higher priority inter-frequency 1 measurement 404 in an available SSB time location, and the measurement interval T_{meas, NR_Inter} 480 can equal to N*DRX cycle, wherein N is a positive integer. The available SSB time location can be selected from time locations that are not used by monitoring paging 402 and the serving cell measurement 403. For example, the UE 110 can select the SSB time locations 440-441 to perform the higher priority inter-frequency 1 measurement 404. Each SSB time location 440-441 is not collided with the SSB time locations that are used by monitoring paging 402 and the serving cell measurement 403.

Similarly, the UE can perform the higher priority inter-frequency 2 measurement 405 in an available SSB time location, wherein the measurement interval T_{meas, NR_Inter} 480 can also equal to N*DRX cycle. The available SSB time location can be selected from time locations that are not used by monitoring paging 402, the serving cell measurement 403, and the higher priority inter-frequency 1 measurement 404. For example, the UE 110 can select the SSB time location 450 to perform the higher priority inter-frequency 2 measurement 405. The SSB time location 450 is not collided with the SSB time locations that are used by monitoring paging 402, the serving cell measurement 403, and the higher priority inter-frequency 1 measurement 404.

In the FIG. 4 example, the UE 110 can perform the serving cell measurement 403 in three SSB time locations 430-432. The SSB time locations 430-432 of the serving cell measurement 403 can be interleaved by the higher priority inter-frequency 1 measurement 404 and the higher priority inter-frequency 2 measurement 405. For example, the SSB time location 430 of the serving cell measurements 403 is in the DRX cycle 410, and the next SSB time location 431 of the serving cell measurements 403 is in the DRX cycle 412. The SSB time location 440 of the higher priority inter-frequency 1 measurement 404 is in the DRX cycle 411 and the SSB time location 450 of the higher priority inter-frequency 2 measurement 405 is in the DRX cycle 413. The SSB time locations 430 and 431 of the serving cell measurement 403 are interleaved by the time location 440 of the higher priority inter-frequency 1 measurement 404 and the time location 450 of the higher priority inter-frequency 2 measurement 405.

Please note that although in the above embodiments, the new serving cell has a higher priority than the current serving cell, the invention is not limited by this. According to different examples, the new serving cell may have a lower priority than the current serving cell. In another examples, the new serving cell may have the equal priority with the current serving cell.

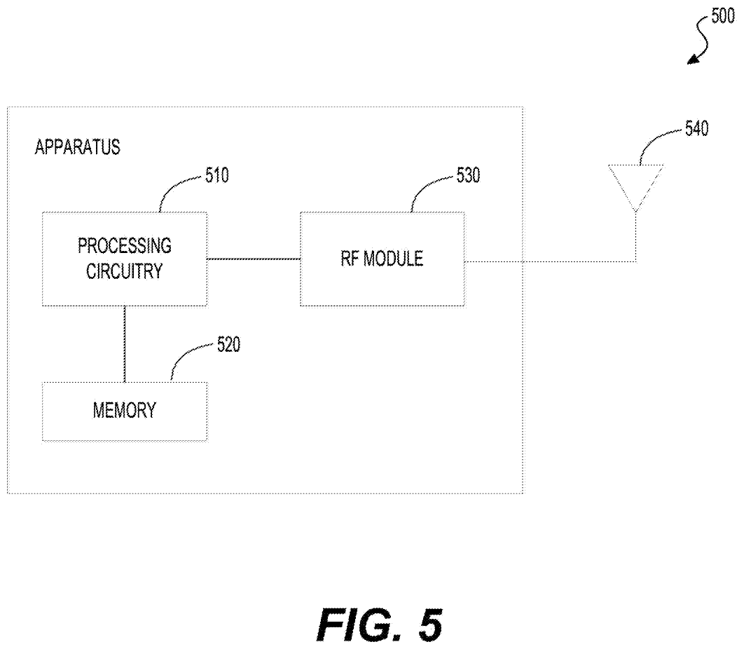

FIG. 5 shows an exemplary apparatus 500 according to embodiments of the disclosure. The apparatus 500 can be configured to perform various functions in accordance with one or more embodiments or examples described herein. Thus, the apparatus 500 can provide means for implementation of techniques, processes, functions, components, systems described herein. For example, the apparatus 500 can be used to implement functions of the UE 110 in various embodiments and examples described herein. The apparatus 500 can be a general purpose computer in some embodiments, and can be a device including specially designed circuits to implement various functions, components, or processes described herein in other embodiments. The apparatus 500 can include processing circuitry 510, a memory 520, a radio frequency (RF) module 530, and an antenna 540.

In various examples, the processing circuitry 510 can include circuitry configured to perform the functions and processes described herein in combination with software or without software. In various examples, the processing circuitry can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 510 can be a central processing unit (CPU) configured to execute program instructions to perform various functions and processes described herein. Accordingly, the memory 520 can be configured to store program instructions. The processing circuitry 510, when executing the program instructions, can perform the functions and processes. The memory 520 can further store other programs or data, such as operating systems, application programs, and the like. The memory can include transitory or non-transitory storage medium. The memory 520 can include a read only memory (ROM), a random access memory (RAM), a flash memory, a solid state memory, a hard disk drive, an optical disk drive, and the like.

The RF module 530 receives processed data signal from the processing circuitry 510 and transmits the signal in a beam-formed wireless communication network via an antenna 540, or vice versa. The RF module 530 can include a digital to analog convertor (DAC), an analog to digital converter (ADC), a frequency up convertor, a frequency down converter, filters, and amplifiers for reception and transmission operations. The RF module 530 can include multi-antenna circuitry (e.g., analog signal phase/amplitude control units) for beamforming operations. The antenna 540 can include one or more antenna arrays.

The apparatus 500 can optionally include other components, such as input and output devices, additional or signal processing circuitry, and the like. Accordingly, the apparatus 500 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

1. An apparatus, comprising processing circuitry configured to:
rank a priority list of frequencies that correspond to a plurality of cells that are part of a communication system, where the plurality of cells includes a current serving cell, an inter-frequency cell, and an intra-frequency cell;
measure a signal performance of the cells in the priority list of frequencies in an unused synchronization signal block (SSB) time location in a discontinuous reception (DRX) cycle; and
select a new serving cell when the measured signal performance of the new serving cell satisfies a cell selection criteria.

2. The apparatus of claim 1, wherein the processing circuitry is further configured to:
measure the signal performance that includes reference signal received power (RSRP) and/or reference signal received quality (RSRQ) of the current serving cell in any SSB time location in each DRX cycle when SSB is Time Division Multiplexed (TDMed) with paging data.

3. The apparatus of claim 1, wherein the processing circuitry is further configured to:
measure the signal performance that includes reference signal received power (RSRP) and/or reference signal received quality (RSRQ) of the current serving cell in any SSB time location in each DRX cycle except SSB time location that is used by paging when SSB is Frequency Division Multiplexed (FDMed) with paging data.

4. The apparatus of claim 1, wherein the processing circuitry is further configured to:
select one or more frequencies in descending order from the priority list, wherein the frequencies correspond to one or more inter-frequency cells; and
measure, in round-robin manner, the signal performances that includes reference signal received power (RSRP) and/or reference signal received quality (RSRQ) of the respective inter-frequency cells at SSB time location that are not used by paging, the current serving cell, and cells in higher-priority frequencies.

5. The apparatus of claim 1, wherein the processing circuitry is further configured to:
select a frequency from the priority list, wherein the frequency corresponds to one or more intra-frequency cells; and
measure, in round-robin manner, the signal performance that includes reference signal received power (RSRP) and/or reference signal received quality (RSRQ) of the respective intra-frequency cells at SSB time location that are not used by paging, the current serving cell, and cells in higher-priority frequencies.

6. The apparatus of claim 1, wherein the processing circuitry is further configured to:
select an inter-frequency cell corresponding to highest priority inter-frequency as the new serving cell when there are at least two inter-frequency cells in which the measured signal performance satisfies the cell selection criteria; or
select an intra-frequency cell as the new serving cell when there are at least two intra-frequency cells in which the measured signal performance satisfies the cell selection criteria.

7. The apparatus of claim 1, wherein the processing circuitry is further configured to:
stay in the current serving cell when the measured signal performance of current serving cell satisfies the cell selection criteria and there is no inter-frequency cell or intra-frequency cell in which the measured signal performance satisfies the cell selection criteria.

8. A method, comprising:
ranking a priority list of frequencies that correspond to a plurality of cells that are part of a communication system, where the plurality of cells includes a current serving cell, an inter-frequency cell, and an intra-frequency cell;
measuring a signal performance of the cells in the priority list of frequencies in an unused synchronization signal block (SSB) time location in a discontinuous reception (DRX) cycle; and
selecting a new serving cell when the measure signal performance of the new serving cell satisfies a cell selection criteria.

9. The method of claim 8, wherein the measuring the signal performance of the cells in the priority list of frequencies in the unused SSB time location in the DRX cycle, further comprises:
measuring the signal performance that includes reference signal received power (RSRP) and/or reference signal received quality (RSRQ) of the current serving cell in any SSB time location in each DRX cycle when SSB is Time Division Multiplexed (TDMed) with paging data.

10. The method of claim 8, wherein the measuring the signal performance of the cells in the priority list of frequencies in the unused SSB time location in the DRX cycle, further comprises:
measuring the signal performance that includes reference signal received power (RSRP) and/or reference signal received quality (RSRQ) of the current serving cell in any SSB time location in each DRX cycle except SSB time location that is used by paging when SSB is Frequency Division Multiplexed (FDMed) with paging data.

11. The method of claim 8, wherein the measuring the signal performance of the cells in the priority list of frequencies in the unused SSB time location in the DRX cycle, further comprises:
selecting one or more frequencies in descending order from the priority list, wherein the frequencies correspond to one or more inter-frequency cells; and
measuring, in round-robin manner, the signal performances that includes reference signal received power (RSRP) and/or reference signal received quality (RSRQ) of the respective inter-frequency cells at SSB time location that are not used by paging, the current serving cell, and cells in higher-priority frequencies.

12. The method of claim 8, wherein the measuring the signal performance of the cells in the priority list of frequencies in the unused SSB time location in the DRX cycle, further comprises:
selecting a frequency from the priority list, wherein the frequency corresponds to one or more intra-frequency cells; and
measuring, in round-robin manner, the signal performance that includes reference signal received power (RSRP) and/or reference signal received quality (RSRQ) of the respective intra-frequency cells at SSB time location that are not used by paging, the current serving cell, and cells in higher-priority frequencies.

13. The method of claim 8, wherein the selecting the new serving cell when the measured signal performance of the new serving cell satisfies the cell selection criteria and the new serving cell has a higher priority than the current serving cell, further comprises:
selecting an inter-frequency cell corresponding to highest priority inter-frequency as the new serving cell when there are at least two inter-frequency cells in which the measured signal performance satisfies the cell selection criteria; or
selecting an intra-frequency cell as the new serving cell when there are at least two intra-frequency cells in which the measured signal performance satisfies the cell selection criteria.

14. The method of claim 8, wherein the selecting the new serving cell when the measured signal performance of the new serving cell satisfies the cell selection criteria and the new serving cell has a higher priority than the current serving cell, further comprises:
staying in the current serving cell when the measured signal performance of current serving cell satisfies the cell selection criteria and there is no inter-frequency cell or intra-frequency cell in which the measured signal performance satisfies the cell selection criteria.

15. A non-transitory computer readable medium storing instructions which, when executed by a processor, cause the processor to perform the steps of:
ranking a priority list of frequencies that correspond to a plurality of cells that are part of a communication system, where the plurality of cells includes a current serving cell, an inter-frequency cell, and an intra-frequency cell;
measuring a signal performance of the cells in the priority list of frequencies in an unused synchronization signal block (SSB) time location in a discontinuous reception (DRX) cycle; and
selecting a new serving cell when the measure signal performance of the new serving cell satisfies a cell selection criteria.

16. The non-transitory computer readable medium of claim 15, wherein the instructions further cause the processor to perform the steps of:
measuring the signal performance that includes reference signal received power (RSRP) and/or reference signal received quality (RSRQ) of the current serving cell in any SSB time location in each DRX cycle when SSB is Time Division Multiplexed (TDMed) with paging data; and
measuring the signal performance that includes reference signal received power (RSRP) and/or reference signal received quality (RSRQ) of the current serving cell in any SSB time location in each DRX cycle except SSB time location that is used by paging when SSB is Frequency Division Multiplexed (FDMed) with paging data.

17. The non-transitory computer readable medium of claim 15, wherein the instructions further cause the processor to perform the steps of:
selecting one or more frequencies in descending order from the priority list, wherein the frequencies correspond to one or more inter-frequency cells; and
measuring, in round-robin manner, the signal performances that includes reference signal received power (RSRP) and/or reference signal received quality (RSRQ) of the respective inter-frequency cells at SSB time location that are not used by paging, the current serving cell, and cells in higher-priority frequencies.

18. The non-transitory computer readable medium of claim 15, wherein the instructions further cause the processor to perform the steps of:
selecting a frequency from the priority list, wherein the frequency corresponds to one or more intra-frequency cells; and
measuring, in round-robin manner, the signal performance that includes reference signal received power (RSRP) and/or reference signal received quality (RSRQ) of the respective intra-frequency cells at SSB time location that are not used by paging, the current serving cell, and cells in higher-priority frequencies.

19. The non-transitory computer readable medium of claim 15, wherein the instructions further cause the processor to perform the steps of:
selecting an inter-frequency cell corresponding to highest priority inter-frequency as the new serving cell when there are at least two inter-frequency cells in which the measured signal performance satisfies the cell selection criteria; or
selecting an intra-frequency cell as the new serving cell when there are at least two intra-frequency cells in which the measured signal performance satisfies the cell selection criteria.

20. The non-transitory computer readable medium of claim 15, wherein the instructions further cause the processor to perform the steps of:
staying in the current serving cell when the measured signal performance of current serving cell satisfies the cell selection criteria and there is no inter-frequency cell or intra-frequency cell in which the measured signal performance satisfies the cell selection criteria.
